(19) United States
(12) Patent Application Publication
(10) Pub. No.: US 2016/0075465 A1
(43) Pub. Date: Mar. 17, 2016

(54) REVERSE TUCK LOCK

(71) Applicant: TED E. WILEY, DOVER, AR (US)

(72) Inventor: TED E. WILEY, DOVER, AR (US)

(21) Appl. No.: 14/947,469

(22) Filed: Nov. 20, 2015

Related U.S. Application Data
(60) Provisional application No. 62/236,419, filed on Oct. 2, 2015.

(51) Int. Cl. B65D 5/30; B31B 1/60; B65D 85/00; B65D 21/02; B65D 5/42

(52) U.S. Cl. CPC B65D 5/308; B65D 21/0212; B65D 5/4212; B65D 85/70; B31B 1/60; B31B 2201/6091

(57) ABSTRACT

A foldable container moveable between a flat configuration and a three-dimensional configuration is provided. The container includes a tab member coupled to a first panel and a tab slot defined by a second panel. The tab member is configured to extend through the tab slot into an interior area of the container. The tab member is moveable between an unlocked configuration and a locked configuration. The unlocked configuration, allows the panels to be easily separated from each other. The locked configuration secures the panels together, thereby securing the container in the three-dimensional configuration. The tab member is moved to the locked configuration and/or is secured in the locked configuration by items placed within the interior area of the container. In some embodiments, additional features secure the tab member in the locked configuration prior to items being placed in the container.

### CROSS REFERENCES

This application claims the benefit of, and priority based upon, co-pending U.S. Provisional Patent Application Ser. No. 62/236,419, titled “Foldable Container”, filed Oct. 2, 2015, the entire disclosure of which is herein incorporated by reference.

### FIELD OF THE INVENTION

The present invention relates generally to foldable containers. More specifically, the present invention is concerned with a locking feature for securing foldable containers in a three-dimensional configuration.

### BACKGROUND OF THE INVENTION

Foldable containers are commonly used to store and/or ship various products, including food items. Foldable containers provide benefits over non-foldable containers at least because foldable containers can be folded from a flat configuration into a three-dimensional configuration.

It is much easier to ship and store containers when they are in a flat configuration. Consequently, containers are usually not moved from their flat configurations into their three-dimensional configurations until they are needed. This often results in the containers being assembled by personnel that may or may not be familiar with the process of folding a particular container. Consequently, it would be beneficial for the container to be designed such that it is relatively obvious how to move the container from a flat configuration into a three-dimensional configuration.

Once the container is folded into a three-dimensional configuration, users are often required to apply tape or some other adhesive to hold the container in the three-dimensional configuration. Consequently, it would be beneficial if the container included one or more feature for securing the container in the three-dimensional configuration without requiring the user to use adhesive to hold the container in the three-dimensional configuration, especially in situations where the use of such adhesive may be prohibited and/or impractical.

A direct-contact ice-pack container is a specific type of container that is particularly well-suited for shipping a variety of products, including raw chicken. Such containers are often fabricated from a single piece of flat material that is folded into a three-dimensional container having a plurality of vertical panels extending upwards from a bottom panel so as to define an interior area for holding the product. In many cases, the material is a special type of corrugated paperboard that includes one or more layer of special material so as to accommodate particular products, such as chicken, being in direct contact with the various panels of the box.

Although chicken is shipped in refrigerated trailers, ice is typically placed on top of the chicken. In this way, the chicken is maintained below a threshold temperature so as to prolong the shelf-life of the chicken, to decrease the risk of the chicken becoming contaminated, and/or to satisfy government regulations. When fully packed, each direct-contact ice-pack container is relatively heavy. For instance, just one container may hold 40 or more pounds of chicken and 10 or more pounds of ice. These containers are then stacked on top of each other in a refrigerated truck and shipped across the country, likely experiencing jostling and impact loads along the way.

As the ice melts, water flows around the chicken, sometimes causing fluid to pool within the container. These pools of fluid can create potential hazards associated with potential contamination of the chicken and/or reduced structural integrity of the container. Additional potential hazards are associated with the fluid refreezing within the container. To minimize these risks, many such containers include one or more drain hole. Unfortunately, the addition of a drain hole can decrease the structural strength of the panel. Consequently, it would be beneficial to include a drain hole in a panel while minimizing potential loss of structural strength of the panel.

Some containers of the prior art include locking features to hold the containers in their three-dimensional configurations during filling, handling, loading, shipping, and unloading. For instance, one design for a top-locking feature includes locking flanges that are coupled to hinge flanges, each hinge flange extending from a recessed portion of the top end of each primary end panel. Secondary end panels extending from each end of each side panel include corresponding recessed portions such that when the locking flanges are folded over the secondary end panels, the hinge flanges are pressed down into the recessed portions of the top ends of the secondary end panels. Unfortunately, this top-locking feature decreases the bearing surface at the top of the end panels. Furthermore, the top-locking feature is ineffective if it is not completely engaged, often causing chicken and/or ice to spill out of the container. Furthermore still, even if the top-locking feature is completely engaged, it is subject to becoming disengaged during filling, handling, loading, shipping, and/or unloading. Furthermore yet, it is often difficult or impossible to inspect the top-locking feature to determine whether the locking feature is disengaged and/or is likely to become disengaged.

Consequently, it would be beneficial to have a locking feature that does not decrease the bearing surface at the top of the end panels. Furthermore, it would be beneficial to have a locking feature that is effective even if it is not completely engaged. Furthermore still, it would be beneficial to have a locking feature that is not subject to becoming disengaged while filling and/or moving the container. Furthermore yet, it would be beneficial to have a locking feature that is easy to inspect so that a user can easily determine whether the locking feature is disengaged and/or is likely to become disengaged.

Various containers of the prior art have been developed to solve various problems and to serve various needs, but each has its limitations and drawbacks. For example, many containers include locking features for a primary panel that extend beyond the primary panel regardless of whether the panel is in a three-dimensional configuration or in a flat configuration. In other words, the locking features are created by adding material to an existing blank for a primary panel. Some such locking features require the locking feature to be cut from a secondary panel and/or from another primary panel. Other such locking features extend beyond the panels such that a larger blank stock of material is required to produce the container. Consequently, it would be beneficial to have a locking feature for a primary panel that does not extend beyond the periphery of the panel when the container is in a flat configuration.

Other limitations of the locking features of the prior art include limited strength capabilities. For instance, many such locking features include one or more feature that weakens the locking feature such that the locking feature is likely to break well before the material of the container has reached its loading capability. In many instances, this deficiency is remedied by adding tape or some other bonding agent at or near the locking feature. In other instances, however, especially when tape and/or other adhesives are not allowed or are otherwise undesirable, the locking feature is simply allowed to remain as a weak-point of the container. In some such embodiments, the locking feature tears or otherwise comes loose, allowing the container to pop open. Consequently, it would be beneficial to have a locking feature that does not require tape or any other bonding material for the locking feature to have a strength capability that is approximately equivalent to the strength capability of the material of the container.

Furthermore, many foldable containers are made from relatively flexible materials, such as corrugated paperboard, so as to accommodate the bending and folding that is required to move the container from a flat configuration to a three-dimensional configuration. To the extent that some foldable containers can be fabricated from stiffer materials, such as plastic, there are few options, many of which are not feasible for use with both flexible material and stiffer material. Consequently, it would be beneficial to have a foldable container that is capable of being fabricated from both stiff material and flexible material.

### SUMMARY OF THE INVENTION

The present invention comprises a foldable container that is movable from a flat configuration to a three-dimensional configuration. While in the flat configuration, various panels of the container are folded relatively flat with each other so that a plurality of containers can be stacked on top of each other for shipping and storage of the containers themselves. While in the three-dimensional configuration, the containers define an interior area for holding items, including food items such as raw chicken, and include structural features that enable a plurality of filled containers to be stacked on top of each other so as to facilitate storing and/or shipping a large quantity of items within the containers.

Embodiments of each container include various novel features to assist users in moving the container from a flat configuration to a three-dimensional configuration and/or for allowing a user to move the container from the three-dimensional configuration back to the flat configuration without adversely affecting the structural integrity of the container. In some embodiments, a key feature is a reverse tuck lock feature that mechanically secures the container in the three-dimensional configuration. As a result, tape, adhesives, and other bonding agents are not required.

Some embodiments of a reverse tuck lock feature includes a tab member that extends through a tab slot into the interior area of the container. While in the interior area, the tab member is moveable between a locked configuration and an unlocked configuration. In the locked configuration, the tab member secures the container in the three-dimensional configuration by inhibiting the tab member's ability to be pulled from the tab slot. In the unlocked configuration, the tab member enables the container to be moved from the three-dimensional configuration by allowing the tab member to be removed from the tab slot.

In some embodiments, the tab member is secured in a locked configuration prior to items being placed in the interior area of the container. Unlike containers of the prior art, however, placing items in the interior area of the present invention actually further secures the tab member in the locked configuration, thereby further securing the container in the three-dimensional configuration. In other words, as the load requirements of the container increase, the stability of the container increases at least because the locking feature of the container becomes less likely to become disengaged.

Even if the locking feature is not fully engaged when the box is moved into the three-dimensional configuration, placing items in the interior area of the container causes the tab member to move to the locked configuration and continues to bias the tab member to the locked configuration. As a result, some embodiments do not allow the container to move from the three-dimensional configuration until after the items are removed from the container.

Some embodiments of the container of the present invention also include one or more feature for providing a user with an indication as to whether the container is in a proper three-dimensional configuration and/or whether a locking feature of the container is properly engaged. For instance, some embodiments include indicia on the tab member that is only visible if the tab member has not been inserted into the interior area of the container and/or indicia on another surface of the container that is only visible if the tab member has been inserted into the interior area of the container. In this way, a user will be able to quickly and easily determine, from a distance, whether the container is properly assembled.

The present invention also solves various other problems and is capable of serving various other needs. For example, some embodiments of the present invention include a locking feature that does not extend beyond the panels of the present invention so that the size of the blank stock for the container is minimized, reducing wasted material. Furthermore, in other embodiments, the locking feature is formed entirely from the primary panel that it is intended to support in the locked configuration or is at least substantially formed from the primary panel with portions extending beyond the primary panel serving a secondary purpose of providing additional features such as defining slots and/or voids. In other words, additional material is not required for the locking feature.

Some embodiments of the present invention still further provide the benefit of providing a locking feature that includes a strength that is substantially the same as the strength of the material of the container itself, without requiring tape or any other bonding agent. Some embodiments of the present invention still further provide the benefit of providing a configuration that can be utilized with a variety of materials, with little or no regard to the relative flexibility of the material of the container. Furthermore, some embodiments of the present invention include one or more feature that makes it impossible or otherwise unlikely that the container will be assembled incorrectly. For example, in some embodiments, the container will not remain in a three-dimensional configuration at all unless the locking features are engaged in a locked configuration.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a top view of an embodiment of the container of the present invention, the container being shown in a flat configuration.

FIG. 2 is a perspective view of the container of FIG. 1, the container being shown in an intermediate configuration between the flat configuration and a three-dimensional configuration, a tab member of the container also being shown in an intermediate configuration between a stowed configuration and a deployed configuration.

FIG. 3 is a perspective view of the container of FIG. 1, the container being shown in a three-dimensional configuration.

FIG. 4 is a top view of an embodiment of the container of the present invention, the container having a plurality of post panels and being shown in a flat configuration.

FIG. 5 is a perspective view of the container of FIG. 4, the container being shown in an intermediate configuration between the flat configuration and a three-dimensional configuration, a tab member of the container also being shown in an intermediate configuration between a stowed configuration and a deployed configuration.

FIG. 6 is a perspective view of the container of FIG. 4, the container being shown in a three-dimensional configuration with the post panels being generally perpendicular to the end panels.

FIG. 7 is a perspective view of the container of FIG. 4, the container being shown in a three-dimensional configuration with the post panels being generally parallel with the end panels.

FIG. 8 is a top view of an embodiment of the container of the present invention, the container being shown in a flat configuration.

FIG. 9 is a top view of an embodiment of the container of the present invention, the container being shown in a flat configuration.

FIG. 10 is a top view of an embodiment of the container of the present invention, the container being shown in a flat configuration.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

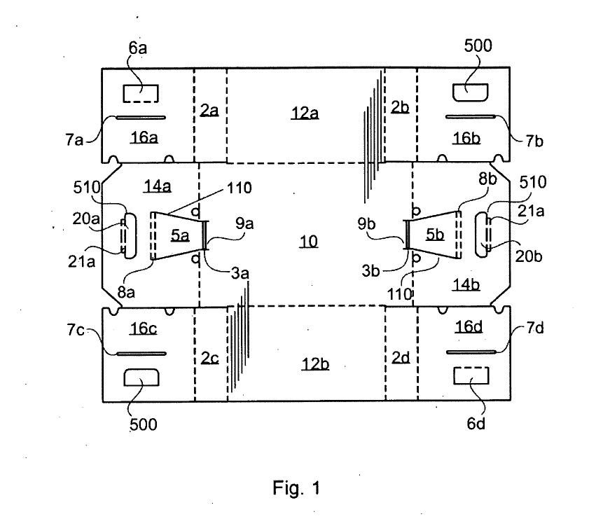

Referring to FIG. 1, a preferred embodiment of a flat pattern of the present invention includes a bottom panel 10, side panels 12a, 12b extending outward from opposed sides of the bottom panel 10, and end panels 14a, 14b extending outward from opposed ends of the bottom panel 10. In some embodiments, the side panels extend substantially between each end of the bottom panel and the end panels extend substantially between each side of the bottom panel such that the panels form a four-sided container when the panels are folded into a three-dimensional configuration. In other embodiments, one or more panel is truncated such that it does not extend to one or more edge of the bottom panel and/or one or more panel is extended so that it extends beyond one or more edge of the bottom panel. For example, FIGS. 1-3 show an embodiment that includes a corner panel 2a-2d extending from each end of two truncated side panels such that the panels form an eight-sided container when the panels are folded into a three-dimensional configuration. It will be appreciated that other embodiments of the present invention include different flat-pattern configurations so as to create three-dimensional containers having various shapes and sizes.

Still referring to FIG. 1, a preferred embodiment of a flat pattern of the present invention further includes at least one side folding panel 16a-16d extending either directly or indirectly from a side panel 12. For example, some embodiments of a four-sided container include a side folding panel 16a-16d extending directly from each end of two side panels. As another example, FIGS. 1-3 show an embodiment of an eight-sided container that includes a side folding panel 16a-16d extending from each corner panel 2a-2d such that the side folding panels 16a-16d each indirectly extend from an end of a truncated side panel. It will be appreciated that other embodiments of the present invention include different flat-pattern configurations having different configurations of folding panels, such as one or more bottom folding panel, top folding panel, and/or end folding panel instead of and/or in addition to one or more side folding panel.

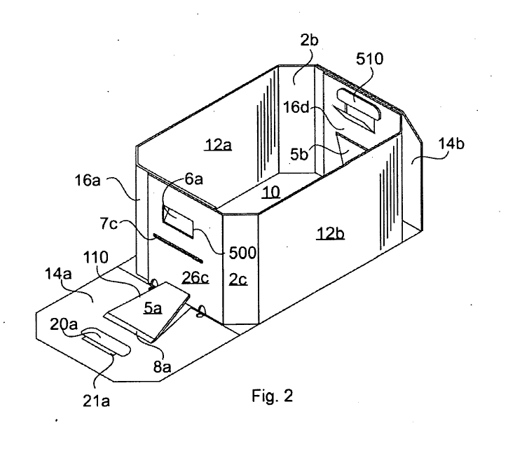

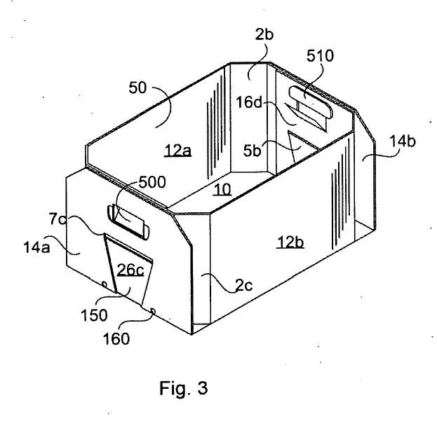

In some embodiments of containers of the present invention, such as the eight-sided container embodiment shown in FIGS. 2 and 3, each side panel, side folding panel, and end panel is generally perpendicular to the bottom panel such that when the bottom panel is horizontal, the other panels extend vertically upward so as to define an interior area 50 for holding items. In some embodiments, each side folding panel 16a-16d is folded against a respective side folding panel such that a tab slot 7a-7d of each side folding panel 16a-16d aligns with a tab slot 7a-7d of the respective side folding panel 16a-16d that it is folded against. In other embodiments, each end panel is folded against one or more side folding panel so that so that a tab member 110 of the end panel can be received by each tab slot 7a-7d of the side folding panels 16a-16d such that the container is locked in a three-dimensional configuration with a reverse tuck lock feature. In some embodiments, the tab member 110 includes a first portion 8a, 8b that is configured to be received by one or more tab slot 7a-7d and a second portion 5a, 5b that extends beyond the one or more tab slot 7a-7d into an interior area 50 of the container. In other embodiments, one or more panel, such as the bottom panel 10 defines a terminal slot 3a, 3b that is configured to receive a portion of the tab member 110 so as to secure the tab member in a locked configuration. In some such embodiments, the panel also includes a tuck flange 9a, 9b adjacent to the terminal slot 3a, 3b. In some such embodiments, the tuck flange 9a, 9b is configured to allow the tab member to move in and out of the terminal slot and/or to retain the tab member within the terminal slot. In some embodiments, the container includes indicia 26a, 26c so as to provide an indication that the tab member has been inserted into the tab slot.

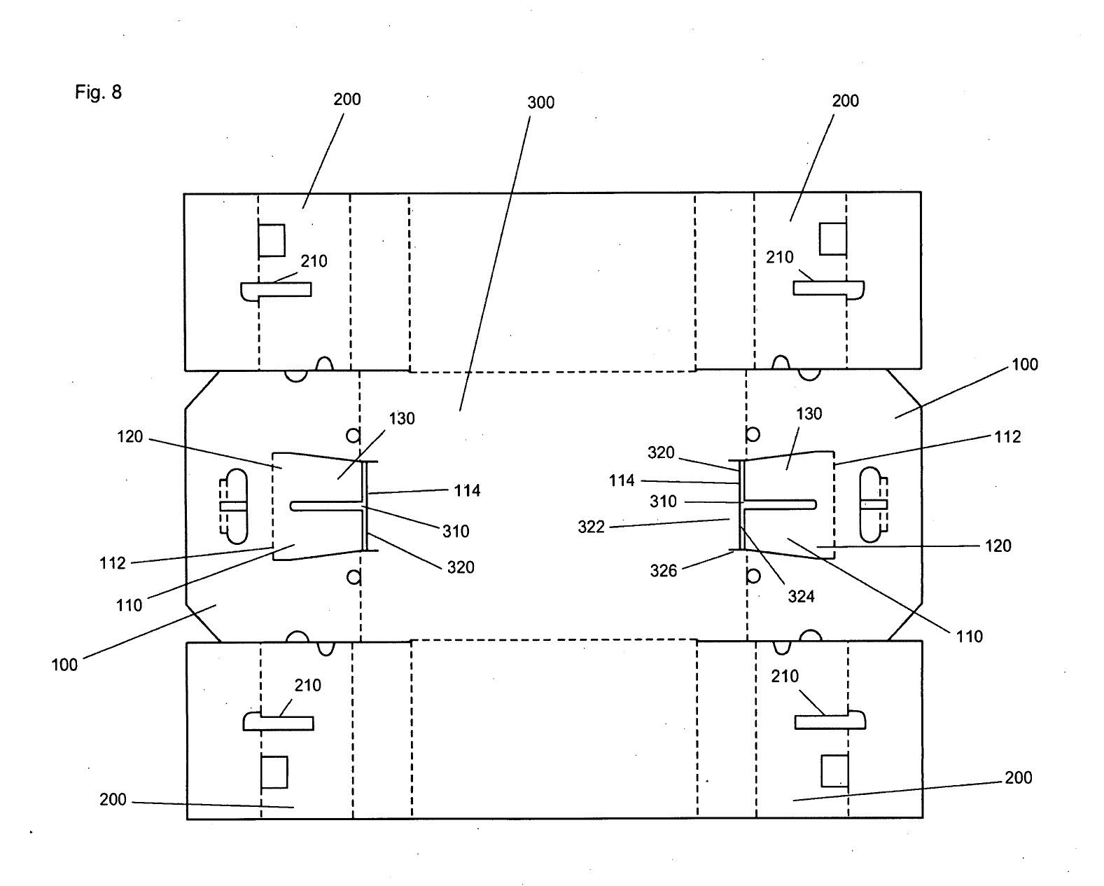

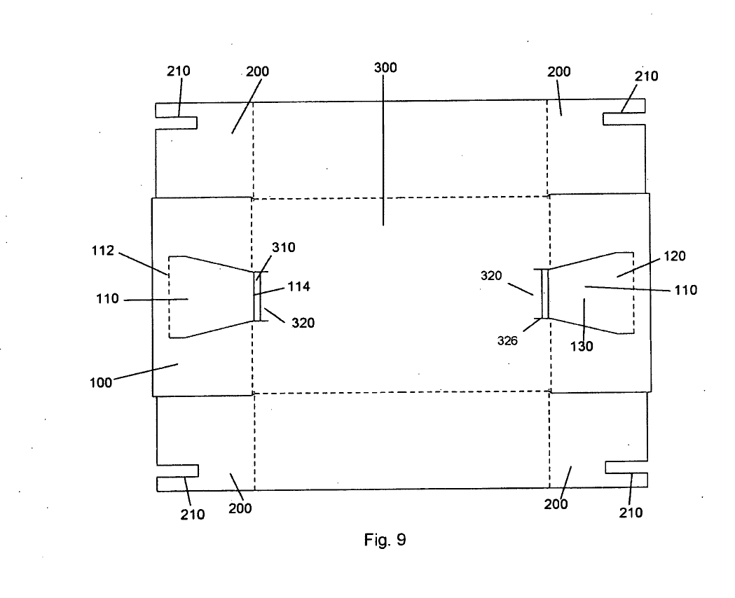

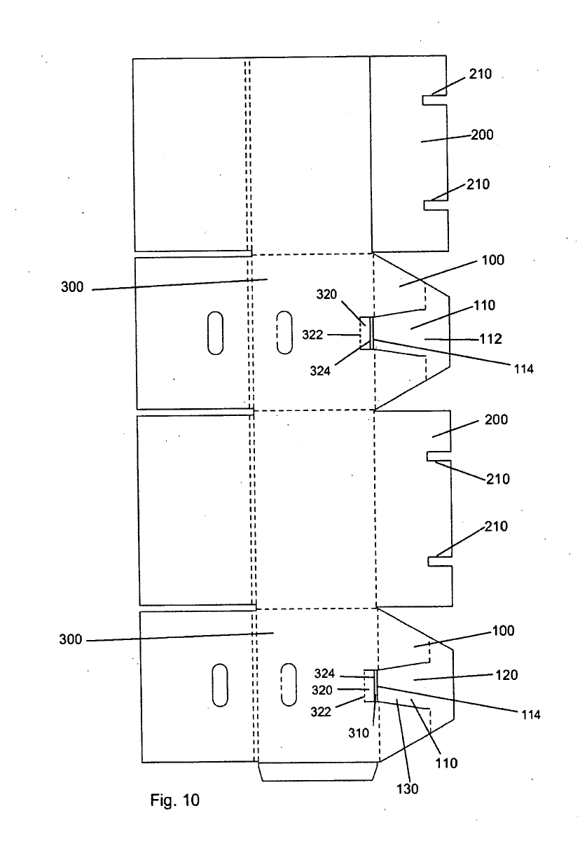

Referring to FIGS. 8-10, a container having a reverse tuck lock feature includes a first panel 100 and a corresponding second panel 200. In some embodiments, the first panel is a primary panel such as an end panel, a side panel, a bottom panel, a top panel, or some other primary panel and the second panel is a folding panel and/or a flange extending from a primary panel other than the first panel. The first panel 100 includes at least part of a tab member 110 and the second panel 200 defines at least part of a corresponding tab slot 210 that is configured to receive the tab member 110 so as to secure the first 100 and second 200 panels in position relative to each other, thereby securing the container in a three-dimensional configuration. It will be appreciated that, in some embodiments, the tab member 110 and/or the tab slot 210 is defined by more than one panel such that each panel is secured relative to the other panels when the tab member 110 is received by the tab slot 210. It will further be appreciated that, in some embodiments, a single tab member is received by more than one tab slot so as to secure the first panel 100 to more than one other panel. It will still further be appreciated that, in other embodiments, a single tab slot receives more than one tab member so as to secure the second panel 200 to more than one other panel.

The tab member 110 includes a proximal end 112 coupled to the first panel 100 and a distal end 114 displaced from the proximal end 112 of the tab member 110. In some embodiments, the tab member 110 includes a first portion 120 extending from the proximal end 112 of the tab member 110 through the tab slot 210 of the second panel 200. In some such embodiments, the first portion 120 of the tab member 110 is substantially perpendicular to the first panel when the tab member 110 is received by the tab slot 210 and the container is in a three-dimensional configuration. In other embodiments, the first portion 120 of the tab member 110 is substantially the same width as the tab slot 210 and has a thickness that is substantially equal to the height of the tab slot 210 such that the tab member 110 substantially fills and/or seals the tab slot 210. In still other embodiments, the first portion 120 of the tab member 110 is sized relative to the tab slot 210 such that when the first portion 120 of the tab member 110 is received by the tab slot 210, the translational movement of the second panel 200 relative to the first panel 100 is prevented or otherwise restricted. In still other embodiments, the second panel 200 rests flat against the first panel 100 when the first portion 120 of the tab member 110 is received by the tab slot 210 and the first portion 120 extends through, but not beyond, the second panel.

In a preferred embodiment, the second portion 130 of the tab member 110 is narrower than the first portion 120 of the tab member and/or the tab slot 210. In this way, the second portion 130 of the tab member 110 is able to more easily pass through the tab slot 210 and/or the risk of damaging the tab member 110 and/or the tab slot 210 is reduced. In some such embodiments, each side of the second portion of the tab slot tapers inward such that the second portion 130 of the tab member 110 generally defines a trapezoid.

In some embodiments, the tab member 110 further includes a second portion 130 extending between the first portion 120 and the distal end 114 of the tab member 110. In some such embodiments, the second portion 130 of the tab member 110 is angled relative to the first portion 120 of the tab member 110 such that the second portion 130 prevents the first portion 120 from sliding out of the tab slot 210 of the second panel 200 so as to prevent the first panel 100 from moving away from the second panel.

The tab member 110 is moveable between a stowed configuration and a deployed configuration. In the stowed configuration, the tab member 110 is parallel with the first panel 100 so as to more easily accommodate shipping and storing the container when the container is in a flat configuration. In the deployed configuration, the tab member 110 is angled away from the first panel 100 so as to more easily accommodate inserting the tab member 110 into the tab slot 210 as the container is moved from a flat configuration to a three-dimensional configuration.

The tab member 110 is also moveable between an unlocked configuration and a locked configuration. In the unlocked configuration, the tab member 110 is configured so that it can be removed from the tab slot 210 with relative ease. In the locked configuration, on the other hand, the tab member 110 is configured such that removal of the tab member 110 from the tab slot 210 is prevented or inhibited, thereby enabling the container to be secured in a three-dimensional configuration. In some embodiments of the tab member 110, the first portion 120 of the tab member 110 is substantially perpendicular to the first 100 and second 200 panels and the second portion 130 of the tab member is angled away from the first portion 120 when the tab member is in the locked configuration. In a preferred embodiment, the second portion 130 of the tab member 110 runs substantially parallel with and/or rests substantially against the second panel 200 when the tab member 110 is in the locked configuration.

In a preferred embodiment, the container includes a third panel 300 that defines a terminal slot 310 that is configured to receive the distal end 114 of the tab member 110 when the container is in the three-dimensional configuration and the tab member 110 is in the locked configuration. In some such embodiments, the third panel includes a tuck flange 320 that is movable between an open configuration and a closed configuration. In the open configuration, the tuck flange 320 allows the tab member 110 to move to the locked configuration by rotating the distal end 114 of the tab member 110 past the tuck flange 320 and into the terminal slot 310. In the closed configuration, the tuck flange 320 retains the tab member 110 in the locked configuration by retaining the distal end 114 of the tab member 110 in the terminal slot 310.

In some embodiments, the tuck flange 320 includes a proximal end 322 hingedly coupled to the third panel 300 and a distal end 324 displaced from the proximal end 322 of the tuck flange 320. In some such embodiments, the distal end 324 of the tuck flange defines an edge of the terminal slot 310 when the tuck flange 320 is in the closed configuration. In other embodiments, the sides of the tuck flange 320 are defined by slits in the third panel 300, each slit extending from the proximal end 322 of the tuck flange 320 to the distal end 324 of the tuck flange 320 so as to allow the tuck flange 320 to rotate relative to the rest of the third panel 300. In some such embodiments, the slit 326 is narrow enough such that the edge of the tuck flange 320 interfaces with the third panel 300 in such a way that the tuck flange 320 is held in the closed configuration. In other such embodiments, the proximal end 322 of the tuck flange 320 is coupled to the third panel 300 in such a way that the tuck flange 320 is biased towards the closed configuration or is otherwise configured so as to hold the tuck flange 320 in the closed configuration.

In some embodiments of the present invention, the terminal slot is at least partially defined by the first panel 100 and/or extends to the first panel 100 such that the first panel 100 defines an edge of the terminal slot. In some such embodiments, the tab member 110 extends to the terminal slot 310 when the container is in the flat configuration. In other such embodiments, the tab member 110 extends into the terminal slot 310 when the container is in the flat configuration such that the distal end 114 of the tab member 110 is formed from at least some of the material that is removed from the third panel 300 to define the terminal slot 310. In still other such embodiments, the tab member 110 extends to the tuck flange 320 such that the distal end 114 of the tab member 110 is proximate to the distal end 324 of the tuck flange 320 when the container is in the flat configuration.

The present invention also pertains to a method of making a container having a reverse tuck feature. In some embodiments, the method includes cutting at least part of a profile of at least one tab member 110 in a first panel 100 such that the first panel 100 defines at least part of a tab member 110 that is hingedly coupled to the first panel 100. In some such embodiments, the first panel 100 is weakened at a proximal end 112 of the tab member 110 so as to enable the tab member 110 to rotate between a stowed configuration and a deployed configuration. In other such embodiments, the tab member 110 is weakened between a first portion 120 and a second portion 130 so as to enable the tab member 110 to move between an unlocked configuration and a locked configuration.

The method also includes cutting at least part of a profile of at least one tab slot 210 in a second panel 200 such that the second panel 200 defines at least part of a tab slot 210 that is configured to receive the tab member 110. In some embodiments, the method also includes marking at least a portion of an outer surface of the second panel 200 with indicia. At least one purpose for marking the second panel 200 is to provide an indication when the tab member is received by the tab slot and/or when the container is secured in a three-dimensional configuration.

In a preferred embodiment, a third panel 300 extends from the bottom edge 102 of the first panel 100. In some embodiments, the third panel 300 is cut to define a terminal slot 310. In some such embodiments, cutting the terminal slot 310 in the third panel 300 coincides with cutting a distal end 114 of the tab member 110 such that the tab member 110 is cut from the first panel 100 and the third panel 300. In this way, the distal end 114 of the tab member 110 is sized to fit snugly within the terminal slot 310. In other such embodiments, the third panel 300 is further cut to define a tuck flange 320. In some such embodiments, the cutting step includes cutting two slits in the third panel, each slit extending away from the terminal slot 310 towards a proximal end 322 of the tuck flange 320. In some such embodiments, the third panel 300 is weakened at the proximal end 322 of the tuck flange 320 so as to enable the tuck flange 320 to rotate between an open configuration and a closed configuration.

The present invention also includes a method of moving the container from a flat configuration to a three-dimensional configuration. The method includes moving the tab member 110 from the stowed configuration to the deployed configuration such as by folding the tab member 110 away from the first panel 100. In some embodiments, moving the tab member 110 to the deployed configuration causes the first panel 100 to define a void 150. In some such embodiments, the void 150 extends from a proximal end 112 of the tab member 110 to a bottom edge 102 of the first panel 100.

The method further includes moving the first 100 and second 200 panels relative to each other so as to enable the tab member 110 to be received by the tab slot 210. The panels are then moved against each other so as to insert the tab member 110 into the tab slot 210. In some embodiments, this process causes the first 100 and second 200 panels to be perpendicular to a third panel 300. In other embodiments, this process results in the container defining an interior area 50 for holding items.

In some embodiments, the method further includes moving the tab member 110 from an unlocked configuration to a locked configuration so as to secure the first panel 100 to the second panel 200, thereby securing the container in the three-dimensional configuration. In some such embodiments, the items themselves exert a force on the tab member 110 so as to move the tab member to the locked configuration. In other such embodiments, a user moves the tab member to the locked configuration. In some such embodiments, a distal end 114 of the tab member 110 is inserted into a terminal slot 310 to secure the tab member 110 in the locked configuration. In some embodiments, the items exert a force on the tab member 110 so as to secure the tab member 110 in the locked configuration. As a result, filling the container with items when the container is in a three-dimensional configuration actually helps to retain the container in the three-dimensional configuration.

In some embodiments, the method still further includes moving a tuck flange 320 from a closed configuration to an open configuration so as to allow the distal end 114 of the tab member 110 to more easily move into the terminal slot 310. The tuck flange 320 is then moved back to the closed configuration so as to secure the distal end 114 of the tab member 110 in the terminal slot 310, thereby securing the tab member 110 in the locked configuration. In some such embodiments, items positioned within the interior area 50 of the container bias the tab member 110 toward the locked configuration such that even if the tuck flange 320 is moved to the open configuration when the items are placed in the container, the tab member 110 will remain in the locked configuration.

Some embodiments of the present invention also include a method of moving the tab member 110 from the locked configuration to the unlocked configuration. In some embodiments, the method includes moving the tuck flange 320 to an open configuration so as to allow the distal end 114 of the tab member 110 to be removed from the terminal slot 310. In this way, the structural integrity of the tab member is preserved.

The present invention also includes a method of moving a container from a three-dimensional configuration to a flat configuration. The method includes removing a tab member 110 from a tab slot 210 so as to allow first 100 and second 200 panels to be folded flat relative to each other. The tab member 110 is then moved to a stowed configuration. In some embodiments, such a step requires the tab member 110 to be received by a void 150 of the first panel 100.

In use, the container of the present invention is quickly and easily movable between a flat configuration and a three-dimensional configuration while maintaining the structural integrity of the container. For instance, bonding agents are not required. Consequently, damage associated with removing bonding agents and/or failure of bonding agents is avoided. Furthermore, some embodiments of the present invention include features that enable the various features of the container to be employed without requiring any of the features to be bent or otherwise manipulated in such a way that can adversely affect the structural integrity of the feature. As a specific example, the tuck flange 320 enables the tab member to fold into a locked configuration without requiring a user to bend a second portion 130 of the tab member 110. Furthermore still, in some embodiments, the tab member 110 is positioned within an interior area 50 of the container. In this way, placing items in the container causes the items to come into contact with the tab member 110 in such a way that the items actually help secure the tab member 110 in a locked configuration, thereby even further preserving the integrity of the tab member.

In still other embodiments, additional features, such as drain holes 160, are positioned relative to other features so that the additional features do not unnecessarily reduce the structural strength of the container. For example, in some embodiments, the proximal end 112 of the tab member 110 is wider than the distal end 114 of the tab member 110, causing the void 150 in the first panel 100 to be wider at the proximal end 112 of the tab member 110 than at the bottom of the void 150. In some such embodiments, drain holes positioned adjacent to the void 150 are able to be positioned so that they do not extend past the overall width of the void 150. In this way, any loss of vertical strength of the first panel in association with adding the drain holes is reduced or eliminated. In some such embodiments where the tab slot 210 has the same or substantially the same width as the proximal end 112 of the tab member 110, any loss of vertical strength of the second panel in association with adding the drain holes is also reduced or eliminated.

The present invention also includes a method of determining whether the container is properly secured in a three-dimensional configuration. In some embodiments, the second panel 200 includes indicia that is visible when the tab member 110 is received by the tab slot 210. In this way, the indicia is capable of providing an indication that the container is secured in a three-dimensional configuration. In other embodiments, the tab member 110 includes indicia that is visible when the tab member 110 is not received by the tab slot 210. In this way, the indicia is capable of providing an indication that the container is not secured in a three-dimensional configuration. In still other embodiments, the tab member is configured to extend beyond one or more edge of the first panel if the tab member is folded in the wrong direction so as to provide an indication that the tab member was not folded correctly. For example, if a correct use of the tab member requires the tab member to be folded down, the tab member extends beyond a top edge of the first panel if the tab member is improperly folded upwards. As another example, if a correct use of the tab member requires the tab member to be folded up, the tab member extends beyond a bottom edge of the first panel if the tab member is improperly folded downwards.

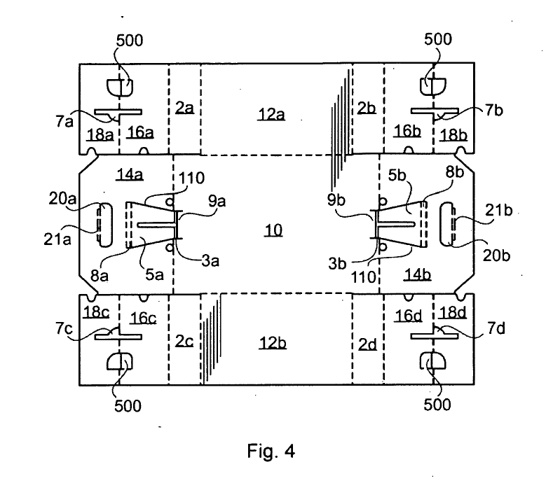

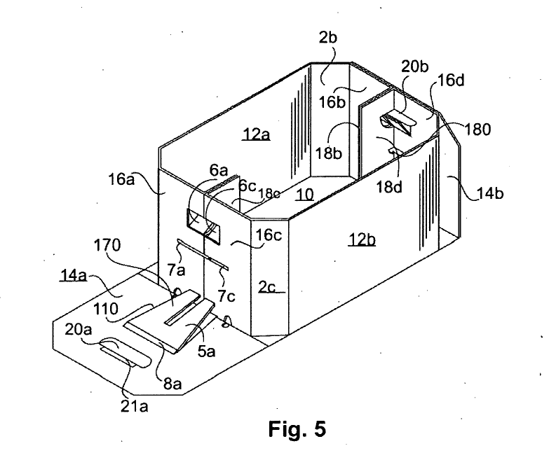

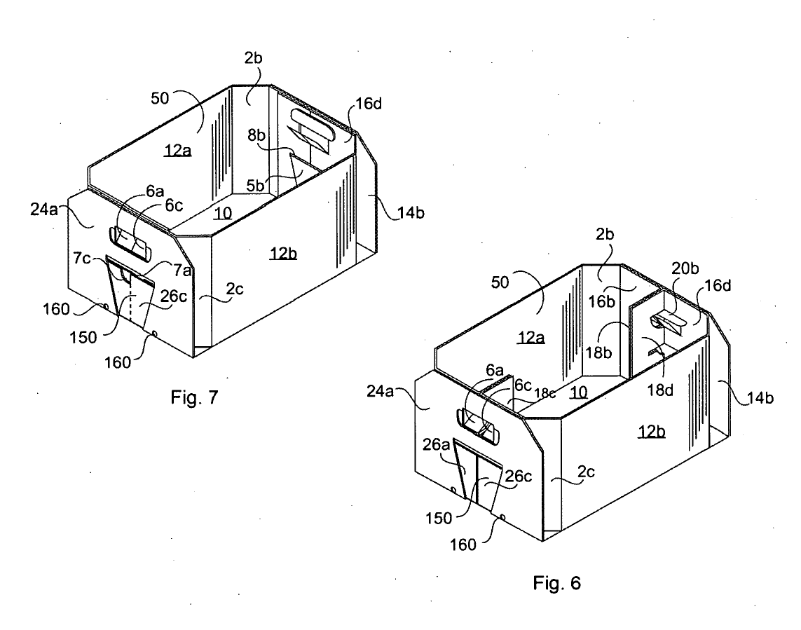

Referring back to FIGS. 4-7, some embodiments of the present invention include one or more post panel 18a-18d. In some such embodiments, the post panel 18a-18d extends from a side folding panel 16a-16d. In other such embodiments, the post panel 18a-18d extends into an interior area 50 of the container in such a way that it is capable of providing the container with additional vertical support for stacking containers on top of each other. For instance, in some embodiments, the post panel 18a-18d has a height that is generally equal to the height of the container such that a load above the container is able to bear directly or indirectly against a top edge of the post panel 18a-18d. The load then migrates through the post panel 18a-18d and out into a support structure positioned below the container. In some such embodiments, the load above the container and/or the support structure positioned below the container is another container.

In some embodiments, one or more post panel 18a-18d is folded against another post panel so as to define a double post panel, thereby decreasing the chance that the post panel will buckle under the weight. In some embodiments, the post panel is positioned within an interior area of the container such that when items are positioned within the interior area, the items are packed around the post panel so as to increase the stability of the post panel, thereby decreasing the chance that the post panel will buckle under the weight. In some embodiments, the post panel 18a-18d extends substantially perpendicularly from one or more other panel, such as a side panel 12a, 12b and/or a side folding panel 16a-16d.

In some embodiments, the one or more post panel 18a-18d extends between multiple tab members 110. In other embodiments, the post panel 18a-18d extends through a clearance slot 170 in a tab member 110. In still other embodiments, the tab member 110 extends through a clearance hole defined by the post panel. In this way, the tab member 110 is capable of being received by one or more tab slot 7a-7d and/or the tab member 110 is capable of moving from an unlocked configuration to a locked configuration.

In other embodiments, the container defines a relatively consistent top edge that is free from notches and recesses. In some such embodiments, the entire top edge of the container is substantially defined by a single planar surface that is generally parallel with, but vertically displaced from the bottom panel of the container.

In still other embodiments, the container defines one or more hand hole 500. In some such embodiments, the end panel 14a, 14b includes a hand hole tab 510 that includes a first portion 21a, 21b hingedly coupled to the end panel 14a, 14b and a second portion 20a, 20b hingedly coupled to the first portion 21a, 21b so that the hand hole tab 510 can be folded away from the end panel to reveal the hand hole 500. In some embodiments, the hand hole 500 extends through one or more side folding panel 16a-16d. In some such embodiments, the first portion 21a, 21b of the hand hole tab 510 is configured to extend through the hand hole 500, but not beyond, the one or more side folding panel 16a-16d, resulting in the second portion 20a, 20b of the hand hole tab 510 extending into an interior area of the container. In some such embodiments, the second portion of the hand hole tab is wider than the hand hole 500 such that the hand hole tab 510 serves as an additional locking feature for securing the end panel 14a, 14b to the one or more side folding panel 16a-16d.

In some embodiments, one or more side folding panel 16a, 16d includes a hand hole receiving panel 6a, 6d hingedly coupled to the side folding panel 16a, 16d. In some such embodiments, the hand hole receiving panel 6a, 6d must be folded away from the side folding panel 16a, 16d to reveal the portion of the hand hole 500 that extends through the side folding panel 16a, 16d.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A container for holding items, including food items such as raw chicken, said container comprising:
a bottom panel;
opposed end panels extending generally vertically from opposed ends of said bottom panel, each end panel including a tab member; and
opposed side panels extending vertically from said bottom panel, each side panel including side folding panels extending from opposed ends of each side panel, each side folding panel defining a tab slot,
wherein each side folding panel is folded against a respective side folding panel of said opposed side panel such that said tab slot in each side folding panel aligns with said tab slot in said respective side folding panel,
wherein each end panel is folded against respective side folding panels and said tab members are received by respective tab slots of respective side folding panels, thereby effectively locking the container in a three-dimensional configuration when the tab members are in a locked configuration,
wherein the container defines an interior area for holding items when the container is in the three-dimensional configuration, and
wherein said tab members extend into said interior area such that items placed within the interior area bias the tab members towards the locked configuration.

2. The container of claim 1, wherein each tab member includes a proximal end hingedly coupled to its respective end panel and a distal end displaced from said proximal end, each tab member further including a first portion extending from said proximal end through said tab slots and a second portion extending from said first portion to said distal end.

3. The container of claim 2, wherein said distal end of each tab member is received by a terminal slot of said bottom panel, when said tab members are in their respective locked configurations.

4. The container of claim 3, wherein said bottom panel defines a tuck flange adjacent to each terminal slot, each tuck flange being movable between an open configuration and a closed configuration, said tab members being free to rotate in and out of respective terminal slots when said tuck flange is in the open configuration.

5. The container of claim 4, wherein said tab members are inhibited from rotating out of respective terminal slots when said tuck flange is in the closed configuration.

6. A container for holding items, including food items such as raw chicken, said container comprising:
a bottom panel;
opposed end panels extending vertically from opposed ends of said bottom panel, each end panel including at least one tab member; and
opposed side panels extending vertically from said bottom panel, each side panel including side folding panels extending from opposed ends of each side panel, each side folding panel defining at least a portion of a tab slot,
wherein said side folding panels are folded against respective end panels such that said tab members are received by respective tab slots of respective side folding panels, thereby effectively locking the container in a three-dimensional configuration when the tab members are in a locked configuration;
wherein the container defines an interior area for holding items when the container is in the three-dimensional configuration, and
wherein said tab members extend into said interior area such that items placed within the interior area bias the tab members towards the locked configuration.

7. The container of claim 6, further comprising a post panel extending from at least one side folding panel, said post panel extending into said interior area of said container so as to provide additional vertical support for stacking containers on top of each other.

8. The container of claim 7, wherein said post panel extends through a clearance slot of said tab member and wherein said tab member extends through a clearance hole of said post panel.

9. The container of claim 6, further comprising a post panel extending from each side folding panel, each post panel being folded against an opposed post panel such that said post panel extend substantially perpendicularly from their respective side panels into said interior area of said container so as to provide additional vertical support for stacking containers on top of each other.

10. The container of claim 9, wherein said post panels extend through clearance slots of said tab members and wherein said tab members extend through clearance holes of said post panels.

11. A container comprising:
a bottom panel;
at least one end panel extending vertically from an end of said bottom panel, said end panel including a tab member; and
at least one side panel extending vertically from said bottom panel, said side panel including at least one side folding panel extending from an end of said side panel, said side folding panel defining a tab slot;
wherein said end panel is folded against said side folding panel and said tab member is received by said tab slot, thereby effectively locking the container in a three-dimensional configuration; and
wherein said tab member being received by said tab slot creates a void within said end panel visually exposing an outer surface of said side folding panel.

12. The container of claim 11, wherein said outer surface of said side folding panel includes indicia that is visible when the tab member is received by the tab slot so as to provide an indication that the container is secured in the three-dimensional configuration.

13. The container of claim 11, wherein an outer surface of said tab member includes indicia that is visible when the tab member is not received by the tab slot so as to provide an indication that the container is not secured in the three-dimensional configuration.

14. A method of securing a plurality of panels in a three-dimensional configuration, the method comprising:
cutting at least part of a profile of at least one tab member in a first panel;
cutting at least part of a profile of at least one tab slot in a second panel;
folding the at least one tab member away from the first panel;
folding the panels until the at least one tab member is capable of being received by the at least one tab slot;
inserting the at least one tab member into the at least one tab slot so as to cause the panels to move into the three-dimensional configuration; and
folding the at least one tab member to a locked configuration so as to retain the panels in the three-dimensional configuration,
wherein the step of folding the at least one tab member to the locked configuration causes the tab member to be folded substantially parallel with the first and second panels, wherein the second panel is positioned between the at least one tab member and the first panel when the at least one tab member is in the locked configuration, and
wherein the tab member is positioned within an interior area defined by said panels when the panels are in the three-dimensional configuration such that items placed within the interior area bias the tab member towards the locked configuration.

15. The method of claim 14, wherein the cutting steps further comprise cutting profiles of a plurality of tab members from one or more panels and cutting profiles of a plurality of corresponding tab slots from one or more panels.

16. The method of claim 15, wherein the folding steps further comprise:
folding each tab member away from its respective panel;
folding the panels until each tab member is capable of being received by at least one corresponding tab slot;
inserting each tab member into the at least one corresponding tab slot so as to cause the panels to move into the three-dimensional configuration; and
folding each tab member to its respective locked configuration so as to retain the panels in the three-dimensional configuration,
wherein each tab member is relatively parallel with its respective panel and with the respective panel of its corresponding tab slot when the tab member is in its locked configuration, and
wherein each respective panel of each corresponding tab slot is positioned between the corresponding tab member and the respective panel of the corresponding tab member.

17. The method of claim 16, wherein each tab slot receives at least one tab member.

18. The method of claim 16, wherein at least one tab member is received by at least two tab slots such that at least two panels are positioned between the at least one tab member and the respective panel of the at least one tab member.

19. The method of claim 14, further comprising:
cutting a terminal slot in a third panel; and
cutting at least part of a profile of the at least one tab member in the third panel,
wherein the at least one tab member includes a proximal end cut from the first panel and a distal end cut from the third panel, the proximal end being hingedly coupled to the first panel and the distal end extending into to the terminal slot when the first panel, the third panel, and the at least one tab member are in a flat configuration.

20. The method of claim 19, wherein the step of folding the at least one tab member to the locked configuration causes the distal end of the tab member to be received by the terminal slot when the panels are in the three-dimensional configuration.

21. The method of claim 20, further comprising cutting slits in the third panel so as to define a tuck flange having a distal end and a proximal end, the proximal end being hingedly coupled to the third panel and the distal end defining an edge of the terminal slot when the tuck flange is in a closed configuration.

22. The method of claim 21, further comprising rotating the tuck flange from the closed configuration to an open configuration so as to allow the tab member to move to the locked configuration by rotating the distal end of the tab member into the terminal slot.

23. The method of claim 22, further comprising rotating the tuck flange back to the closed configuration so as to retain the tab member in the locked configuration by retaining the distal end of the tab member in the terminal slot.
